(19) United States
(12) Patent Application Publication
(10) Pub. No.: US 2005/0157646 A1
(43) Pub. Date: Jul. 21, 2005

(54) System and method of network congestion control by UDP source throttling

(75) Inventors: Sreenivas Addagatla, San Diego, CA (US); Bhaskar Goddanakoppalu, San Diego, CA (US); Krishna Kumar, San Diego, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/758,854

(22) Filed: Jan. 16, 2004

(51) Int. Cl. H04L 12/26

(52) U.S. Cl. 370/232

(57) ABSTRACT

A system and method of bi-directional and unidirectional communications is provided. The system includes a first host capable of transmitting multiplexed data at a first data transfer rate. A second host is provided that is capable of receiving multiplexed data at a second data transfer rate. The system further includes a data throttle that limits the first data transfer rate to a throttle value that is less than or equal to the lesser one of the first data transfer rate and the second data transfer rate. The system is operable on a UDP transport layer and an IP network layer and may be implemented by API calls to a sockets layer.

### FIELD OF THE INVENTION

The present invention generally relates to systems and methods of the exchange of data over a network and, more particularly to congestion control of the exchange of data over an Internet Protocol (IP) network between two network entities using User Datagram Protocol (UDP) by throttling the data at its source.

### BACKGROUND OF THE INVENTION

Today, an organization's computer network has become its circulatory system. Organizations have combined desktop work stations, servers, and hosts into Local Area Network (LAN) communities. These Local Area Networks have been connected to other Local Area Networks and to Wide Area Networks (WANs). Furthermore, with the proliferation of wireless technologies in networking, a wireless interface such as, for example, the air-interface within a Code Division Multiple Access (CDMA) network may impose a bandwidth limitation on the network. It has become a necessity of day-to-day operation that pairs of systems must be able to communicate when they need to, without regard to where they may be located in the network and without unnecessary delay or data loss.

During the early years of network computing, proprietary networking protocols were the norm within isolated networks. However, the development of the Internet Protocol (IP) family of protocols has led to an impressive degree of interworking, which generally allows end-user applications to work very well between systems in a network. Implementations are based on written standards that have been made available by volunteers from dozens of computer vendors, hardware component vendors and independent software companies. These standards have been facilitated by the development of the Open Systems Interconnection (OSI) Reference Model introduced by the International Organization for Standardization (ISO).

The Internet is a set of networks connected by gateways, which are generally referred to as routers. Routers added filtering and firewall capability to provide more control over broadcast domains, limit broadcast traffic and enhance security. A router is able to choose the best path through the network due to embedded intelligence. This added intelligence also allowed routers to build redundant paths to destinations when possible. Nevertheless, the added complexity of best path selection capability accorded by the embedded intelligence increased the port cost of routers and caused substantial latency overhead. Shared-media networks comprising distributed client/server data traffic, expanded user populations and more complex applications gave birth to new bandwidth bottlenecks. Such congestion produced unpredictable network response times, the inability to support the delay-sensitive applications and higher network failure rates.

Congestion control in modern networks is increasingly becoming an important issue. The explosive growth of Internet applications such as the World Wide Web (WWW) has pushed current technology to its limit, and it is clear that faster transport and improved congestion control mechanisms are required. As a result, many equipment vendors and service providers are turning to advanced networking technology to provide adequate solutions to the complex quality of service (QoS) management issues involved. Examples include asynchronous transfer mode (ATM) networks and emerging Internet Protocol (IP) network services. Nevertheless, there is still the need to support a host of existing legacy IP protocols within these newer paradigms such as the ubiquitous TCP transport-layer protocol that has long been the workhorse transport protocol in IP networks, widely used by web-browsers, file/email transfer services, etc. and the UDP transport-layer protocol.

Transmission Control Protocol (TCP) is a part of the TCP/IP protocol family that has gained the position as one of the world's most important data communication protocols with the success of the Internet. TCP provides a reliable data connection between devices using TCP/IP protocols. TCP operates on top of IP that is used for packing the data into data packets, called datagrams, and for transmitting across the network.

The Internet Protocol (IP) is a network layer protocol that routes data across an Internet. The Internet Protocol was designed to accommodate the use of hosts and routers built by different vendors, encompass a growing variety of growing network types, enable the network to grow without interrupting servers, and support a higher-layer of session and message-oriented services. The IP network layer allows integration of LAN “islands.”

However, IP doesn't contain any flow control or retransmission mechanisms. That is why TCP is typically used on top of it. More particularly, TCP uses acknowledgments for detecting lost data packets. TCP/IP networks are nowadays probably the most important of all networks, and operate on top of several (physical) networks, such as the ATM networks mentioned above. These underlying networks may offer some information about the condition of network and traffic, which may be used to provide feedback regarding congestion.

Unlike TCP, User Datagram Protocol (UDP) is a connectionless and unreliable transport-layer protocol. UDP provides minimal application multiplexing without reliable delivery, flow and congestion control at a network node identified by an IP address. The UDP protocol is extremely simplistic in nature. Data from an application layer is handed down to the transport layer and encapsulated in a UDP datagram. The datagram is sent to the host with no mechanism to guarantee the safe arrival to the destination device. Any checking is pushed back to the application layer if reliability is desired. However, the simplicity of UDP reduces the overhead from using the protocol and the services may be adequate in many cases. For instance, IP Multimedia System, (IMS) of 3G wireless networks is specified to use Real-time Transport Protocol (RTP) for exchanging media streams and RTP typically runs over UDP.

Because UDP does not provide any congestion control, a high volume of data packets sent from a source to a destination may be lost or congest in the network. Examples of such congestion points include routers and other packet processing platforms such as a Packet Data Serving Node (PDSN) in a Code Division Multiple Access (CDMA) packet data system. This congestion occurs because IP stack implementations are generally not aware of bandwidth constraints (even though they are aware of the Maximum Transmission Unit (MTU)). Such implementations usually depend on the link layer for some kind of flow control. However, a link layer typically does not provide congestion control services.

Generally, this issue is more pronounced in wireless 3G networks where high speed audio and video applications exchange data over UDP (RTP being the upper layer protocol). Also, when terminals are used in a relay model (e.g., a terminal connected to a personal computer as a high speed modem), a typical personal computer's resident IP stack will attempt to pump as much data as quickly as possible. Constrained bandwidth and the high error rate intrinsic nature of the wireless medium may result in excessive dropped packets and congested networks.

Assuming a lack of bandwidth knowledge by the transport/network layers, UDP congestion can be even more pronounced if any of the following conditions described below occur. First, if the source and destination have different total bandwidth towards the nearest routers or other packet processing platforms (e.g., source has a 114 kbps connection and destination has a 82 kbps connection), network congestion is possible. Next, if the source and the destination have the same bandwidth connections, but the network between the source and destination is congested (e.g., both source and destination are connected at 114 kbps bandwidth, but the network's current throughput is only about 80 kbps between the source and the destination) as such congestion may be caused by routers and other packet processing platforms, congestion of the network is possible. Further, if large network-layer buffers are found at the source (regardless of the bandwidth; this is typically the case with personal computers connected over modems) the upper layers may send large amounts of data as long as the network-layer buffers do not become full. Also, the effective sending rate of data would be that which the modem can deliver (e.g., 256 kbps), rather than what the destination expected (e.g., 80 kbps).

Prior attempts at congestion control in UDP networks involve the use of signaling of congestion notifications within the network. However, such signaling may be difficult and costly to implement or may not be compatible with all networks. Other attempts at resolving congestion challenges have involved the development of new protocols such as, for instance, the Datagram Congestion Control Protocol (DCCP), which is a new IP family protocol that is similar to UDP.

The embodiments of the present invention are provided to overcome the challenges of the prior art, some of which are described above.

### SUMMARY OF THE INVENTION

In light of the foregoing background, embodiments of the present invention provide an improved system and method for decreasing congestion in an IP network utilizing a UDP transport layer. The embodiments of the invention provide systems and methods of source-based throttling for UDP data. The embodiments involve throttling the UDP traffic at the source to a predetermined bandwidth limit that is known in advance or is negotiated during session set-up using, for example, Session Initiation Protocol (SIP). For example, the source may have obtained a bandwidth limit or throttle value of 113 kbps. This bandwidth limit may have been predetermined or it may have been negotiated during a session set-up such as, for example, a SIP process. The underlying operating system (within a user terminal) is notified of the negotiated bandwidth limit and monitors UDP traffic so that at any given instance, the bandwidth does not exceed the throttle value.

One aspect of the invention is a communications system having a first host that is capable of transmitting multiplexed data at a first data transfer rate. A second host is provided that is capable of receiving multiplexed data at a second data transfer rate. A data throttle is also provided. The data throttle limits the first data transfer rate to a throttle value that is less than or equal to the lesser one of the first data transfer rate and the second data transfer rate.

Another aspect of the invention is a communications system having a first host that is capable of transmitting multiplexed data at a first data transfer rate. The first host is further comprised of a data throttle. The system is further comprised of a second host that is capable of receiving multiplexed data at a second data transfer rate. Intervening between the first host and the second host is a network that is capable of transmitting multiplexed data at a third data transfer rate. In the system of this embodiment, the data throttle limits the first data transfer rate to a value that is less than or equal to the minimum of the three (the first, the second and the third) data transfer rates.

In one aspect of the invention, the second data transfer rate and the third data transfer rate are obtained during a session set-up process such as, for example, a Session Initiation Protocol (SIP).

In one aspect of the invention, the first host is further comprised of an applications layer, a sockets layer, a transport layer, and a network layer and the data throttle operates by one or more application program interface (API) calls from the applications layer to the sockets layer. The API calls limit the transmission data rate to a value that is less than or equal to the lesser one of the first data transfer rate and the second data transfer rate.

In another aspect of the invention, the transport layer of the source host is comprised of a User Datagram Protocol (UDP) and the network layer of the source host is comprised of an Internet Protocol (IP).

Another aspect of the invention is a method of communication between a first host and a second host. This method is comprised of the steps of first obtaining a throttle value bandwidth and setting the maximum data transfer rate of the first host to the throttle value bandwidth. The last step of this aspect is transmitting data packets from the first host to the second host at a data transfer rate that is less than or equal to the throttle value bandwidth.

Another aspect of the invention is where setting the maximum data transfer rate of the first host to the throttle value bandwidth is accomplished by Application Programming Interface (API) calls from an application executing on the first host to a sockets layer of the first host.

Yet another aspect of the invention is where transmitting data packets from the first host to the second host at a data transfer rate that is less than or equal to the throttle value bandwidth is accomplished by use of a User Datagram Protocol (UDP) transport layer and an Internet Protocol (IP) network layer.

Another aspect of the invention is a method of communication between a first host and a second host through a network. This method is comprised of the steps of first obtaining a throttle value bandwidth and setting the maximum data transfer rate of the first host to the throttle value bandwidth. The final step in this embodiment of the method is transmitting data packets from the first host to the second host through the network at a data transfer rate that is less than or equal to the throttle value bandwidth.

These, and more aspects of the invention are described in greater detail in the drawings and description herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A shows a system for unidirectional or bi-directional communications between two hosts wherein each host may be a source host and a destination host, according to one embodiment of the present invention;

FIGS. 1B and 1C are alternative embodiments of the system of FIG. 1A;

FIG. 2 is a schematic block diagram of a host, according to one embodiment of the present invention;

FIG. 3 is a schematic block diagram of a mobile station that may operate as a host, according to embodiments of the present invention;

FIG. 4 illustrates a multi-layer protocol stack of a host in accordance with one embodiment of the present invention, where the protocol stack comprises the OSI model including seven layers;

FIG. 5 illustrates a comparison of the OSI functionality of a host in accordance with an embodiment of the present invention, and the generic OSI model;

FIG. 6A illustrates an exemplary system for bi-directional or unidirectional communications between two hosts wherein each host may be a source host and a destination host;

FIG. 6B illustrates the general system of FIG. 6A further comprised of a UDP throttle and a proxy server, according to an embodiment of the present invention;

FIG. 7 is an exemplary control flow diagram more particularly illustrating a method of initiating a communication session between a source and destination;

FIG. 8 illustrates an exemplary SIP packet;

FIG. 9A illustrates an exemplary communication between two host applications where each host has an exemplary multi-level protocol stack such that API calls are made from the host applications to a sockets layer, in an embodiment of the invention;

FIG. 9B illustrates in more detail exemplary API calls that are made from the host applications to the sockets layer of FIG. 9A, in an embodiment of the invention;

FIG. 10 is an exemplary flowchart which illustrates a method of bi-directional or unidirectional communications between two hosts wherein each host may be a source host and a destination host, in accordance with one embodiment of the present invention; and

FIG. 11 is another exemplary flowchart which illustrates a method of bi-directional or unidirectional communications between two hosts wherein each host may be a source host and a destination host, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The embodiments of the present invention may be described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. For example, embodiments of the data throttle of the present invention van be implemented on a computer device such as a packet processing platform or may be implemented through software such as API calls at a source.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

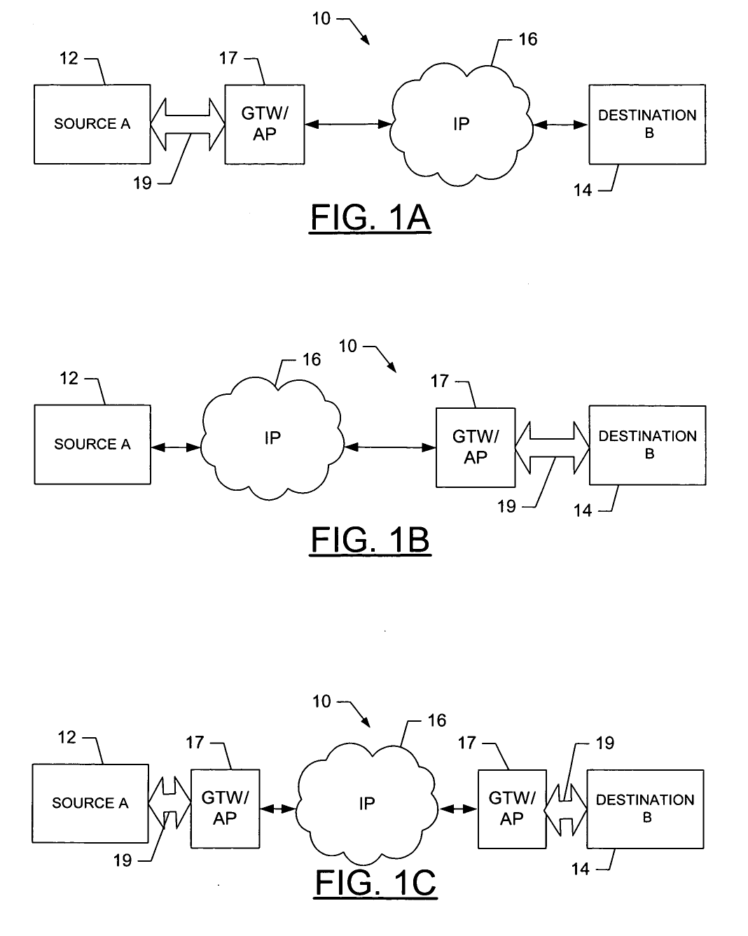

Referring now to FIG. 1A, a general system 10 is shown for bi-directional or unidirectional communications, according to embodiments of the present invention. The system generally includes two end points or hosts, namely a source A 12 and a destination B 14. Source A 12 and destination B 14 are hosts. A host, including source A 12 and destination B 14, may be any device or entity capable of communicating with other hosts via an IP communications network. The hosts can communicate with one another in accordance with any of a number of different wireline and/or wireless techniques, such as the User Datagram Protocol (UDP) and/or the Transmission Control Protocol (TCP). The system 10 also includes a communications network, such as an Internet Protocol (IP) communications network 16 through which source A 12 and destination B 14 communicate.

Each of source A 12 and destination B 14 can be coupled to the network 16 directly, but in one embodiment, one or both of the hosts are coupled to the network via a gateway (GTW) or access point (AP) network entity 17 (referred to as a GTW/AP), with FIG. 1A illustrating source A 12 coupled to the network 16 via such a network entity. In the embodiment illustrated in FIG. 1B, destination B 14 is coupled to the network 16 via a network entity 17. In the embodiment illustrated in FIG. 1C, source A 12 and destination B 14 are both coupled to the network 16 via a network entity 17. In other embodiments (not shown), source A 12 and destination B 14 may both be coupled directly to the network 16. For each host coupled to the network via a GTW/AP 17, the system also typically includes a full-duplex single-path section 19 between the host (e.g., source A 12) and the GTW/AP 17. The host can communicate with the GTW/AP 17 in any of a number of different manners, but in one embodiment, communicates in accordance with a Point-to-Point-Protocol (PPP) or other similar protocol, such as the Serial Line Internet Protocol (SLIP). However, one characteristic of the system 10 is that the single path section contributes to a TCP round trip time (RTT) significantly.

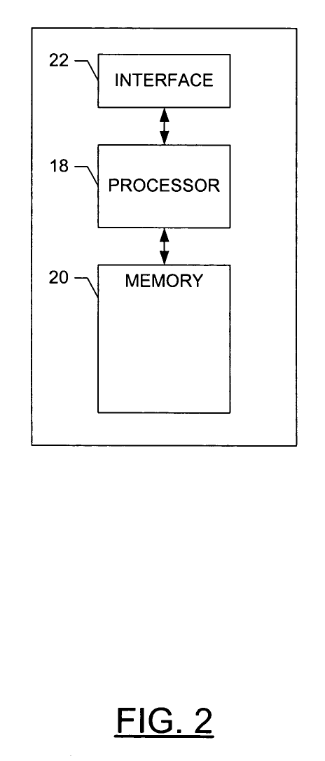

Referring now to FIG. 2, a block diagram of an entity capable of operating as a host (e.g., source A 12 and/or destination B 14), an originating SIP client, a terminating SIP client, or a GTW/AP 17 is shown in accordance with one embodiment of the present invention. As shown, the entity can generally include a processor 18 connected to a memory 20 and an interface 22. The memory 20 typically includes software applications, instructions or the like for the processor to perform steps associated with operation of the host in accordance with embodiments of the present invention. For example, as a host, the memory may include user or host applications such as a conventional Web browser for communicating in accordance with the hypertext transfer protocol (HTTP), a file transfer (e.g., FTP) application, a Telnet application, a peer-to-peer access application, or the like.

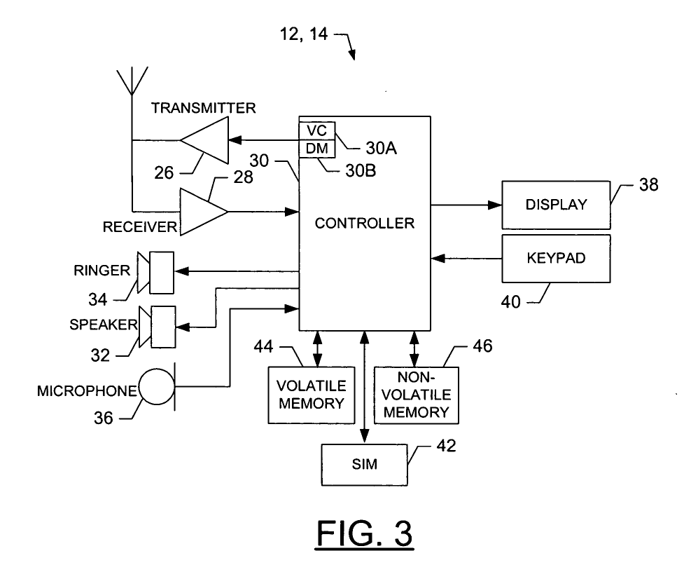

Reference is now drawn to FIG. 3, which illustrates a functional diagram of a mobile station that may act as a host, such as source A 12 and/or destination B 14, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 26, a receiver 28, and a controller 30 that provides signals to and receives signals from the transmitter 26 and receiver 28, respectively. These signals include signaling information in accordance with the air interface standard of an applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA), and/or in accordance with 3G wireless communication protocols such as CDMA2000 and wide-band CDMA (WCDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 30 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 30A, and may include an internal data modem (DM) 30B. Further, the controller may include the functionally to operate one or more software applications, which may be stored in memory.

The mobile station also comprises a user interface including a conventional earphone or speaker 32, a ringer 34, a microphone 36, a display 38, and a user input interface, all of which are coupled to the controller 30. The user input interface, which allows the mobile station to receive data, can comprise any of a number of devices allowing the mobile station to receive data, such as a keypad 40, a touch display (not shown) or other input device. In embodiments including a keypad, the keypad includes the conventional numeric (0-9) and related keys (#, *), and other keys used for operating the mobile station.

The mobile station can also include memory, such as a subscriber identity module (SIM) 42, a removable user identity module (R-UIM) or the like, which typically stores information elements related to a mobile subscriber. In addition to the SIM, the mobile station can include other memory. In this regard, the mobile station can include volatile memory 44, such as volatile Random Access Memory (RAM) including a cache area for the temporary storage of data. The mobile station can also include other non-volatile memory 46, which can be embedded and/or may be removable. The non-volatile memory can additionally or alternatively comprise an EEPROM, flash memory or the like. The memories can store any of a number of pieces of information, and data, used by the mobile station to implement the functions of the mobile station. For example, the memories can store user or host applications such as a conventional Web browser for communicating in accordance with the HTTP, a file transfer (e.g., FTP) application, a Telnet application, a peer-to-peer access application, or the like. Additionally, the memories can store a buffer for implementing a transmission window and storage for implementing a reception window, as such is described below. One or more of the mobile stations are capable of operating as an originating SIP client and one or more of the mobile terminals are capable of operating as a terminating SIP client, which can be capable of communicating with an originating SIP client in accordance with SIP. While the use of SIP is commonplace during a session start-up process, it is to be recognized that the embodiments of the invention may utilize protocols other than SIP during the start-up process.

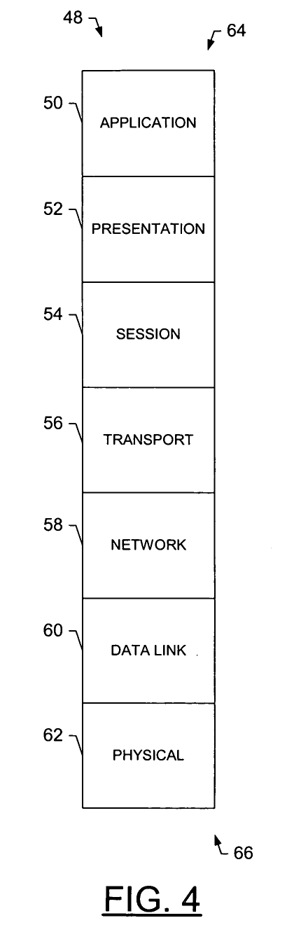

FIG. 4 illustrates a protocol stack of a host (e.g., source A 12 and/or destination B 14) in accordance with embodiments of the present invention, where the protocol stack may be implemented in software, hardware, firmware or combinations of the same. More particularly, FIG. 4 illustrates the Open Systems Interconnection (OSI) model 48 which includes seven layers, including an application layer 50, presentation layer 52, session layer 54, transport layer 56, network layer 58, data link layer 60 and physical layer 62. The OSI model was developed by the International Organization for Standardization (ISO) and is described in ISO 7498, entitled: The OSI Reference Model, the contents of which is incorporated herein by reference in its entirety.

Each layer of the OSI model 48 performs a specific data communications task, a service to and for the layer that precedes it (e.g., the network layer 58 provides a service for the transport layer 56). The process can be likened to placing a letter in a series of envelopes before it is sent through the postal system. Each succeeding envelope adds another layer of processing or overhead information necessary to process the transaction. Together, all the envelopes help make sure the letter gets to the right address and that the message received is identical to the message sent. Once the entire package is received at its destination, the envelopes are opened one by one until the letter itself emerges exactly as written.

In data communication between two hosts (e.g., source A 12 and destination B 14), however, each end user is unaware of the envelopes, which perform their functions transparently. For example, an automatic bank teller transaction can be tracked through a host operating in accordance with the multi-layer OSI model, where the host operating in accordance with the multi-layer OSI model may be referred to as an open system or a multiple layer system. In such an instance, one multiple layer system (e.g., Open System A) can provide an application layer that is an interface to a user attempting a transaction, while another multiple layer system (Open System B) can provide an application layer that interfaces with application software in a bank's host computer. The corresponding layers in Open Systems A and B can be referred to as peer layers and communicate through peer protocols. Such peer protocols provide communication support for a user's application, performing transaction-related tasks such as debiting an account, dispensing currency, or crediting an account.

Actual data flow between two open systems (e.g., Open System A and Open System B), however, is from top 64 to bottom 66 in one open system (e.g., Open System A, the source), across the communications line, and then from bottom 66 to top 64 in the open system (e.g., Open System B, the destination). Each time that user application data passes downward from one layer to the next layer in the same system more processing information is added. When that information is removed and processed by the peer layer in the other system, it causes various tasks (error correction, flow control, etc.) to be performed.

The ISO has specifically defined all seven layers, which are summarized below in the order in which the data actually flows as they leave the source.

Layer 7, the application layer 50, provides for a user application (e.g., getting money from an automatic bank teller machine, etc.) to interface with the OSI application layer. And as indicated above, the OSI application layer can have a corresponding peer layer in another open system communicating with the application layer (e.g., the bank's host computer).

Layer 6, the presentation layer 52, makes sure the user information (e.g., a request for $50 in cash to be debited from a checking account) is in a format (i.e., syntax or sequence of ones and zeros) the destination open system can understand or interpret.

Layer 5, the session layer 54, provides synchronization control of data between the open systems (i.e., makes sure the bit configurations that pass through layer 5 at the source are the same as those that pass through layer 5 at the destination).

Layer 4, the transport layer 56, ensures that an end-to-end connection has been established between the two open systems and is often reliable (i.e., layer 4 at the destination confirms the request for a connection, so to speak, that it has received from layer 4 at the source).

Layer 3, the network layer 58, provides routing and relaying of data through the network (among other things, at layer 3 on the outbound side an address gets placed on the envelope which is then read by layer 3 at the destination).

Layer 2, the data link layer 60, includes flow control of data as messages pass down through this layer in one open system and up through the peer layer in the other open system.

Layer 1, the physical interface layer 62, includes the ways in which data communications equipment is connected mechanically and electrically, and the means by which the data moves across those physical connections from layer 1 at the source to layer 1 at the destination.

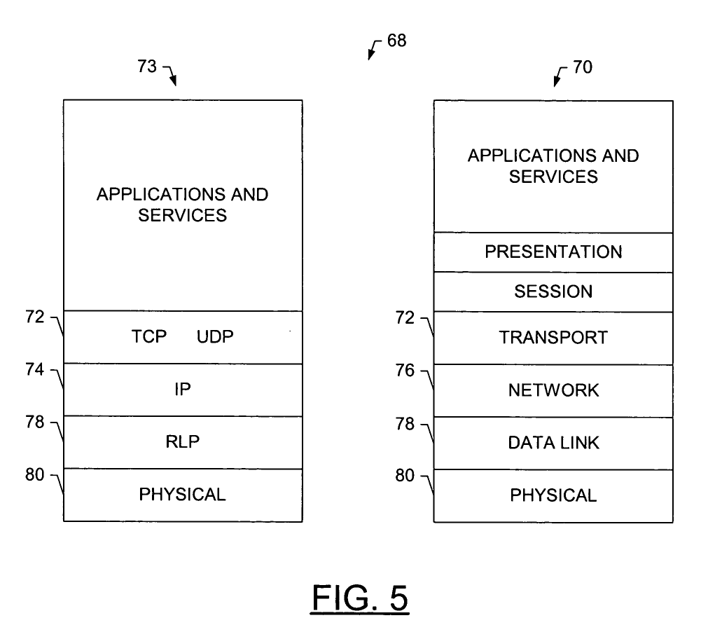

FIG. 5 illustrates a comparison 68 of the OSI functionality of source A and/or destination B in accordance with embodiments of the present invention as suggested by data structure 73 and the generic OSI model 70. More particularly, FIG. 5 illustrates where the Internet Protocol (IP) network layer 74 fits in the OSI seven layer model 70. As shown, the transport layer 72 provides data connection services to applications and may contain mechanisms that guarantee that data is delivered error-free, without omissions and in sequence. The transport layer in the TCP/IP and UDP model 73 sends segments by passing them to the IP layer, which routes them to the destination. The transport layer accepts incoming segments from the IP layer, determines which application is the recipient, and passes the data to that application in the order in which it was sent.

Thus, the IP layer 74 performs network layer functions and routes data between systems. Data may traverse a single link or may be relayed across several links in an Internet. Data is carried in units called datagrams, which include an IP header that contains layer 3 78 addressing information. Routers examine the destination address in the IP header in order to direct datagrams to their destinations. The IP layer is called connectionless because every datagram is routed independently and the IP layer does not guarantee reliable or in-sequence delivery of datagrams. The IP layer routes its traffic without caring which application-to-application interaction a particular datagram belongs to. The transport layer 72, which may include a Transmission Control Protocol (TCP) and User Datagram Protocol (UDP) layer. In the case of TCP, a reliable data connection is provided between devices using TCP/IP protocols. UDP is known as an “unreliable” protocol because it does not verify that packets have reached their destination, and gives no guarantee that they will arrive in order. If an application requires these guarantees, it must provide them itself, or use TCP. The TCP and UDP layer operates on top of the IP layer 74 that is used for packing the data to data packets, called datagrams, and for transmitting the datagrams across the data link layer and underlying network via physical layer 80. The data link layer can operate in accordance with any of a number of different protocols, such as the Radio Link Protocol (RLP), Ethernet, Wireless Ethernet, SLIP, Token Ring, ATM, etc.

Like a number of other data link layer protocols, RLP layer 78 provides for retransmission of data in case the receiver did not correctly receive the data. As will be appreciated, the IP protocol doesn't contain any flow control or retransmission mechanisms. That is why the TCP layer 72 and RLP layer 78 are typically used on top of the IP layer 74. In this regard, TCP protocols provide acknowledgments for detecting lost data packets.

UDP is typically used for applications such as streaming media (audio and video, etc) where the time TCP requires for retransmission and re-ordering might not be available, or for simple query/response applications like domain-name server (DNS) lookups, where the overhead of setting up a reliable connection is disproportionately large. Both TCP and UDP are used to carry a number of higher-level applications. The applications at any given network address are distinguished by their TCP or UDP Port Number. By convention certain well known ports are associated with specific applications. RTP, as may be used in an IP Multimedia system of a 3G wireless network, is an attempt to provide a compromise between TCP and raw UDP. Although RTP uses the UDP packet format as a basis, it provides a function that is at the same protocol layer.

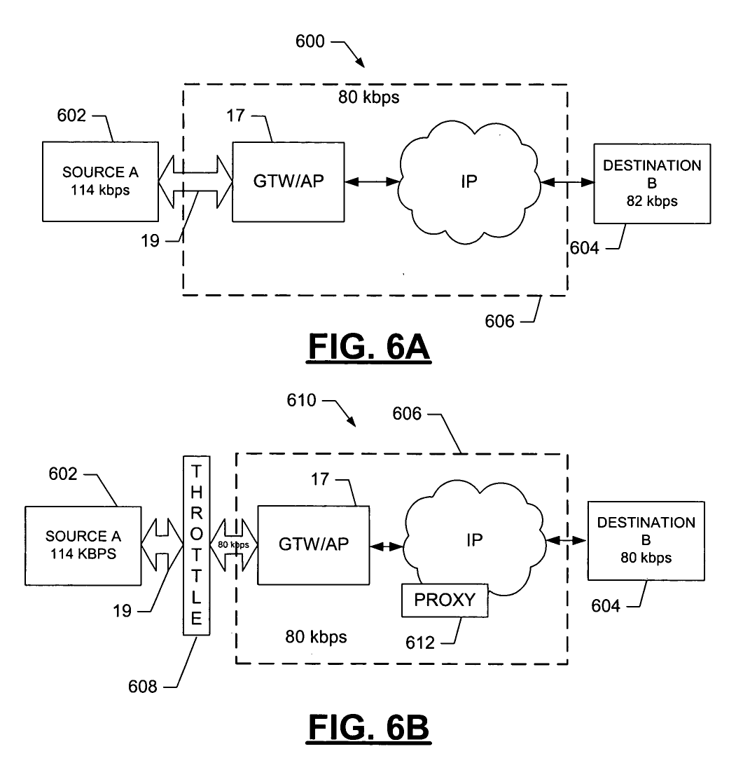

FIG. 6A illustrates a general system for bi-directional or unidirectional communications between two hosts wherein each host may be a source host and a destination host, according to embodiments of the present invention. The system 600 is generally comprised of two end points or hosts, namely a source A 602 and a destination B 604, and a network 606 that includes GTW/AP 17. In the exemplary embodiment of FIG. 6A, source A 602 has a 114 kbps connection, destination B 604 has an 82 kbps connection and the network 606 between source A and destination B has a throughput of 80 kbps. Connectionless transport-layer protocols such as, for example, UDP, may have congested communications between source A 602 and destination B 604 because of the differing bandwidths of the elements that comprise the system 600. FIG. 6B illustrates the same general system as shown in FIG. 6A, however, in FIG. 6B a UDP throttle 608 and a proxy server 612 have been added to the system 610 and comprise part of the system 610.

The UDP throttle 608 of the system 610 of FIG. 6B serves to establish a bandwidth limit or throttle value for communications. The terms “bandwidth limit” and “throttle value” may be used interchangeably herein. According to the embodiments of this invention, this bandwidth limit is typically established during a session set-up process such as, for example, a SIP session; however, the bandwidth limit may be a predetermined value that is provided to the UDP throttle 608. SIP will provide a negotiated bandwidth limit in a manner that is known in the art, though other methods of obtaining or determining the bandwidth limit may be used. In FIG. 6B, the UDP throttle 608 is shown to be associated with source A 602, however, in other embodiments the UDP throttle 608 may be co-located with the source 602 or it may be a distinct element in communication with the source 602.

SIP is an application-layer control (signaling) protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP invitations used to create sessions carry session descriptions which allow participants to agree on a set of compatible media types. SIP supports user mobility by proxying and redirecting requests to the user's current location. This ability is implemented by the use of a proxy server 612 such as, for example, a SIP proxy server as shown in the system 610 of FIG. 6B wherein users can register their current location. SIP is not tied to any particular conference control protocol. SIP is designed to be independent of the lower-layer transport protocol and can be extended with additional capabilities (see, e.g., Internet Engineering Task Force (IETF) request for comment document RFC 3261, entitled: SIP: Session Initiation Protocol, June 2002, the contents of which are hereby incorporated by reference in its entirety).

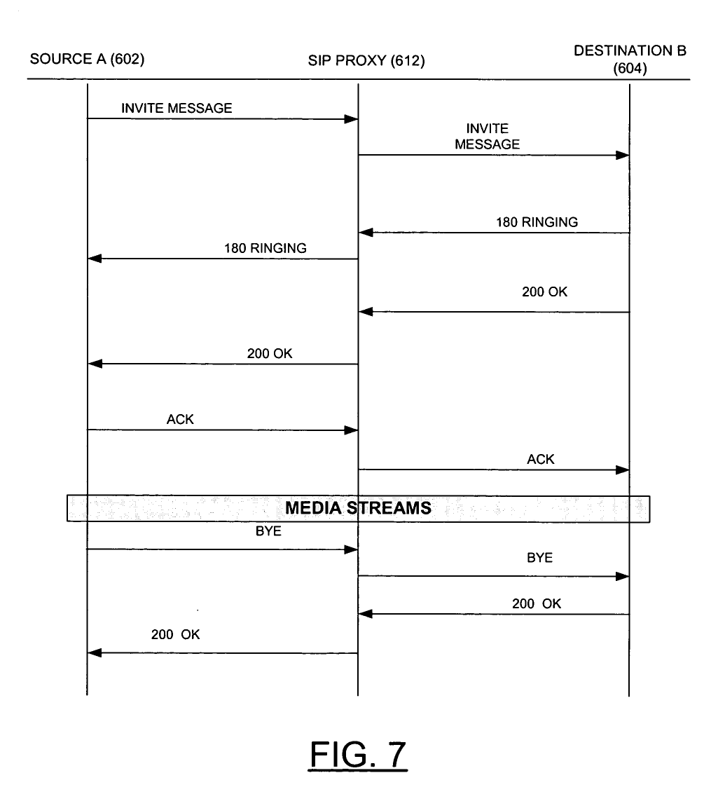

Now referring to FIG. 7, the proxy server 612 is therefore capable of receiving and forwarding SIP signaling messages, such as SIP signaling messages to and/or from a network node comprising a fixed terminal operating as an originating SIP client 602. SIP is independent of the packet layer and only requires an unreliable datagram service, as it provides its own reliability mechanism. While SIP typically is used over UDP or TCP, it could, without technical changes, be run over IPX, frame relay, ATM AAL5 or X.25, etc., in rough order of desirability. The embodiments of this invention provide for a bandwidth limit to be established during the SIP session such that the bandwidth of the source 602 is limited (or “throttled”) to minimize or prevent congestion caused by a source, network and destination having differing bandwidth connections or throughput.

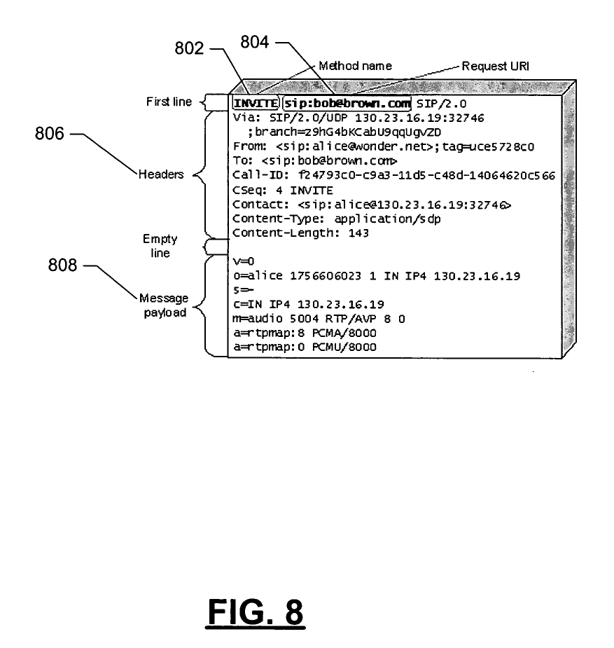

An exemplary SIP packet is illustrated in FIG. 8. This exemplary packet 800 is comprised of a method name 802 (e.g., “Invite”), a request URI 804, (the Request-URI is a Uniform Resource Identifier and identifies the resource upon which to apply the request), headers 806, and message payload 808. In one embodiment of the invention, information about the bandwidth connection of the source 602, the destination 604, or any packet-processing platforms (not shown) that handle the communications between the source 602 and destination 604 is included in the header 806. The bandwidth connection of the destination 604 is included in the header 806 of the return message. Also, information about the bandwidth of packet processing platforms in the network 606 is returned to the source 602. Therefore, the source 602 will have bandwidth information about itself, the destination 604 and the network 606 between the source 602 and the destination 604. The source 602 may then set a bandwidth limit (“throttle value”) that is at the lowest value of bandwidth connection or throughput of the source 602, destination 604 or network 606. For example, if the source 602 has a bandwidth connection of 114 kbps, the network 606 (comprised of one or more packet processing platforms) has an overall throughput of 80 kbps, and the destination 604 has a network bandwidth connection of 82 kbps, then the source 602 will set the bandwidth limit or throttle value to 80 kbps.

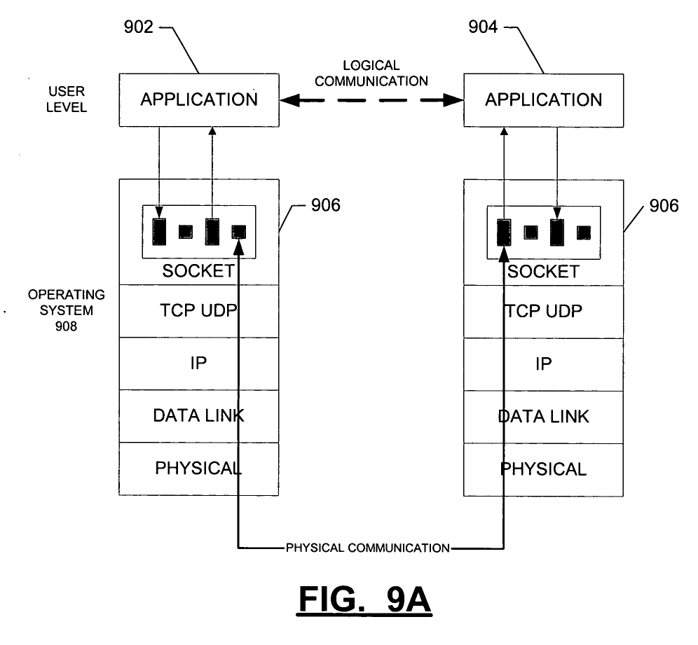

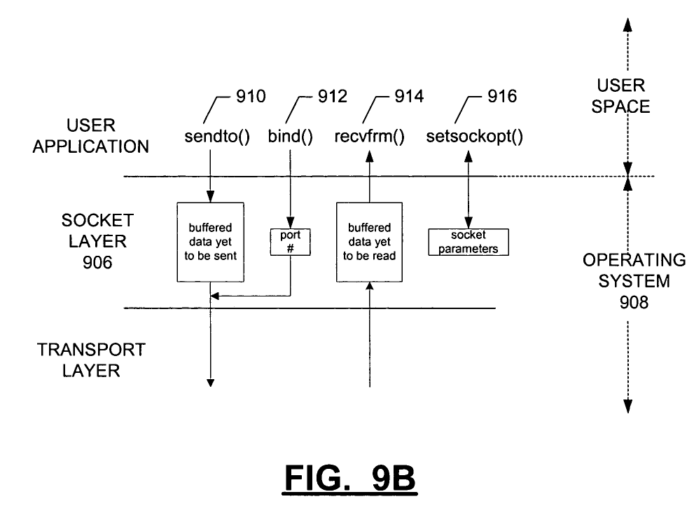

In one embodiment, the UDP throttle 608 is implemented by API calls to the operating system of the source 602 such as, for example, API calls to a sockets interface. Other API's include Winsock TM, Java TM, transport layer interface (TLI), Novell TM Netware API, etc. FIG. 9A illustrates an exemplary communication between two applications (Application A 902 and Application B 904) in an embodiment of the invention. In this embodiment, API calls are made by the application (e.g., Application A 902, Application B 904) to the sockets layer 906 of the operating system 908. FIG. 9B is a more detailed illustration of the embodiment of FIG. 9A. As shown in this embodiment, the standard API calls of “sendto( )” 910, “bind( )” 912, “recvfrm( )” 914, and “setsockopt( )” 916 are shown being made to an exemplary sockets layer 906 of an operating system 908 in an embodiment of the invention. Generally, each of these API calls has one or more variables that are passed when they are called, as is illustrated by the parentheses, “( )”. These standard API calls are only exemplary in nature and provided for illustrative purpose, there are a number of additional standard API calls.

In various embodiments, the UDP throttle 608 is implemented by API calls. For example, in one embodiment the “sendto( )” 910 API call may be modified to send data only when the bandwidth for the last configurable amount of time (e.g., last one second) does not exceed the bandwidth limit established earlier either during the SIP negotiation process or provided to the UDP throttle 608 by other means. The “sendto( )” 910 system call will block the sending of data if the throttle value will be exceeded. In this regard, the “sendto( )” 910 API will delay sending the data so that the bandwidth limit is not exceeded or until a time the bandwidth is less than the limit (normally, the “sendto( )” 910 API will block only if there are no buffers to hold the packet to be sent). In another embodiment, a bandwidth limit (throttle value) is set for the source's 602 socket used to send data. The means for setting the socket's throttle value is by the “setsockopt( )” 916 API call. An additional option is included in the passed variables of the “setsockopt( )” 916 API call that sets the bandwidth limit (i.e., throttle value) for that socket in bits per second (bps).

In other embodiments, a new library of API calls may be developed that maintain the bandwidth limit and throttling data. For instance, a new API such as “sendto_throttled( )” may be developed that limits data sent to less than the obtained throttle value. In another embodiment, an exemplary API such as, for example, “setsockopt_bandwidth( )” may be used to set the bandwidth limit of a socket to less than the obtained throttle value.

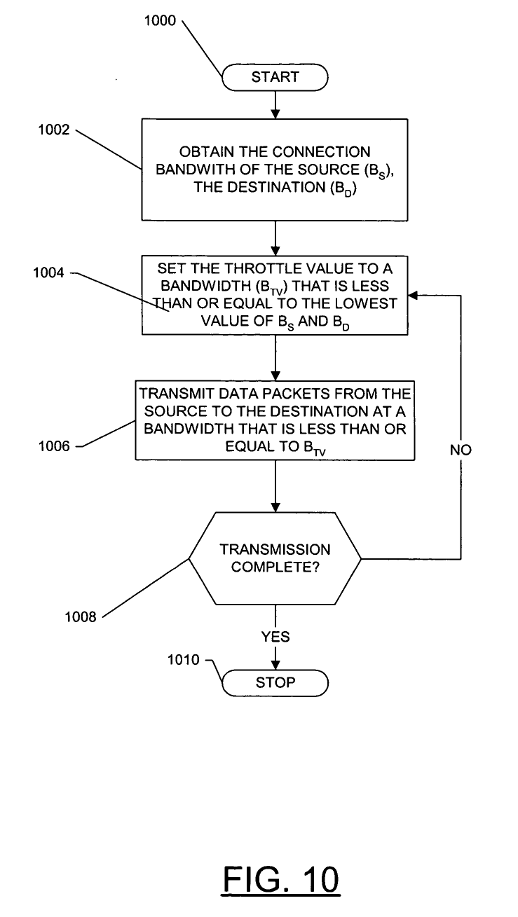

Reference will now be made to FIG. 10, which illustrates a method of bi-directional or unidirectional communications between two hosts wherein each host may be a source host and a destination host, in accordance with one embodiment of the present invention. The process begins at step 1000. As shown, a method of bi-directional or unidirectional communications between source A 12 and destination B 14 generally includes source A obtaining the data transfer rates or bandwidth of the source (B_{S}) and the destination (B_{D}), as shown in block 1002. Source A may determine the transfer rates in accordance with any of a number of different techniques such as, for example, during a set-up process such as a SIP process, as previously described or the data transmission rates may be provided to source A by means outside the scope of this invention. For example, in the context of a dial-up Digital Subscriber Line (DSL) communication, the data rates can be obtained from communication (e.g., modem) settings at source A. Also, for example, in the context of CDMA2000 communication, the respective rates can be obtained from system capabilities.

At step 1004, a throttle value bandwidth (B_{TV}) is set that is less than or equal to the lowest data rate of B_{S}, and B_{D}. The throttle value bandwidth (B_{TV}) is set by the source as the maximum data rate limit for data transmitted from the source to the destination. At step 1006, data packets are transmitted from the source to the destination at a data transfer rate that is less than or equal to the throttle value (B_{TV}). At step 1006 it is determined whether there is more data to be transmitted. If there is more data to be transmitted, then the process returns to step 1004, otherwise the process goes to step 1010, where it ends.

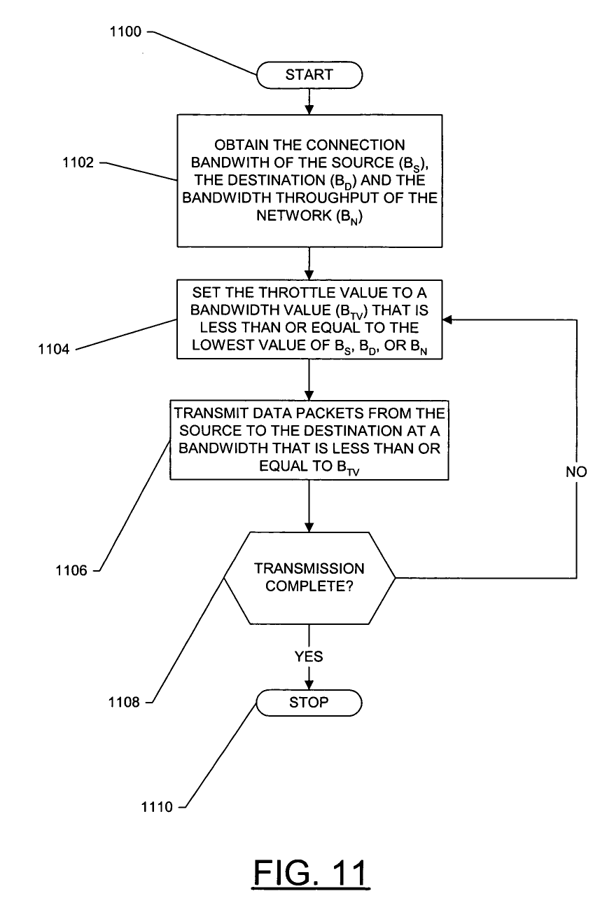

Reference will now be made to FIG. 11, which illustrates another method of bi-directional or unidirectional communications between two hosts and through a network wherein each host may be a source host and a destination host, in accordance with one embodiment of the present invention. The process begins at step 1100. As shown, a method of bi-directional or unidirectional communications between source A 12 and destination B 14 generally includes source A obtaining the data transfer rates or bandwidth of source A (B_{S}) and of destination B (B_{D}), as shown in block 1102. The throughput data rate (B_{N}) of any intervening packet processing platforms such as, for example, one or more routers, is also determined. Source A can determine the transfer rates in accordance with any of a number of different techniques such as during the set-up process by SIP, as previously described or by obtaining a predetermined bandwidth limit in a manner not within the scope of this invention. For example, in the context of a dial-up Digital Subscriber Line (DSL) communication, the data rates can be obtained from communication (e.g., modem) settings at source A. Also, for example, in the context of CDMA2000 communication, the respective rates can be obtained from system capabilities.

At step 1104 a throttle value bandwidth (B_{TV}) is set that is less than or equal to the lowest data rate of B_{S}, B_{D}, and B_{N}. The throttle value bandwidth (B_{TV}) is set by the source as the maximum data rate limit for date transmitted from the source, through the network, to the destination. At step 1106, data packets are transmitted from the source, through the network, to the destination at a data rate that is less than or equal to the throttle value (B_{TV}). At step 1108, it is determined whether there is more data to be transmitted. If there is more data to be transmitted, then the process returns to step 1104, otherwise the process goes to step 1110, where it ends.

Therefore, the embodiments of the present invention overcome many of the challenges associated with the congestion of UDP networks and avoids many of the problems caused by congested UDP networks including unpredictable network response times, the inability to support delay-sensitive applications and higher network failure rates.

Many modifications and other embodiments of the invention will come to mind to one skilled in the art to which this invention pertains having the benefit of the teachings presented in the foregoing descriptions and the associated drawings. We have described the embodiments of this invention as obtaining a bandwidth limit either by negotiation during a set-up process such as SIP or by receiving a predetermined bandwidth limit from another source and implementing data throttling through software calls. However, it is to be recognized that the desired effect of the invention may be implemented in other ways, such as software and/or hardware that is not described herein. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A communications system comprising:
a first host capable of transmitting multiplexed data at a first data transfer rate;
a second host capable of receiving multiplexed data at a second data transfer rate; and
a data throttle, wherein the data throttle limits the first data transfer rate to a throttle value that is less than or equal to the lesser one of the first data transfer rate and the second data transfer rate.

2. The system of claim 1 further comprising a network having a third data transfer rate and wherein the data throttle limits the first data transfer rate to the throttle value that is less than or equal to the lesser one of the first data transfer rate, the second data transfer rate, and the third data transfer rate.

3. The system of claim 1, wherein the throttle value transfer rate is obtained during a communications set-up period.

4. The system of claim 1, wherein the throttle value is a predetermined value.

5. The system of claim 1 wherein the first host is further comprised of an applications layer, a sockets layer, a transport layer, and a network layer.

6. The system of claim 5, wherein the data throttle operates by one or more application program interface (API) calls from the applications layer to the sockets layer, said API calls limiting the transmission data rate to the throttle value transfer rate

7. The system of claim 5, wherein the transport layer is comprised of a User Datagram Protocol (UDP) and the network layer is comprised of an Internet Protocol (IP).

8. A communications system comprising:
a first host capable of transmitting multiplexed data at a first data transfer rate;
a second host capable of receiving multiplexed data at a second data transfer rate;
a network capable of transmitting multiplexed data at a third data transfer rate; and
a data throttle capable of limiting the bandwidth of data transmitted from the first host to the second host to a throttle value.

9. The system of claim 8, wherein the data throttle limits the throttle value transfer rate to a value that is less than or equal to the lesser one of the first data transfer rate and the second data transfer rate.

10. The system of claim 9, wherein the throttle value is a predetermined value.

11. The system of claim 9, wherein the throttle value is determined during a communications start-up process.

12. The system of claim 9, wherein the communications start-up process is a Session Initiation Protocol (SIP) process.

13. The system of claim 8 wherein the first host is further comprised of an applications layer, a sockets layer, a transport layer, and a network layer.

14. The system of claim 13, wherein the data throttle operates by one or more application program interface (API) calls from the applications layer to the sockets layer, said API calls limiting the transmission data rate to a value that is less than or equal to the lesser one of the first data transfer rate and the second data transfer rate.

15. The system of claim 13, wherein the transport layer is comprised of a User Datagram Protocol (UDP) and the network layer is comprised of an Internet Protocol (IP).

16. A method of communication between a first host and a second host, comprising:
obtaining a data transfer rate of the first host and a data transfer rate of the second host at which the second host may receive data;
setting a throttle value that is less than or equal to the lesser of the data transfer rate of the first host and the data rate of the second host; and
transmitting data packets from the first host to the second host at a data transfer rate that is less than or equal to the throttle value.

17. The method of claim 16, wherein setting the maximum data transfer rate of the first host to the throttle value is accomplished by Application Programming Interface (API) calls from an application executing on the first host to a sockets layer of the first host.

18. The method of claim 16, wherein transmitting data packets from the first host to the second host at a data transfer rate that is less than or equal to the throttle value is accomplished by use of a User Datagram Protocol (UDP) transport layer and an Internet Protocol network layer.

19. A method of communication across a network and between a first host and a second host, comprising:
receiving a throttle value that is less than or equal to the lesser of a data transfer rate of the first host, a data transfer rate of the second host, and a data transfer rate of the network rate;
setting the maximum data transfer rate of the first host to the throttle value; and
transmitting data packets from the first host to the second host at a data transfer rate that is less than or equal to the throttle value.

20. The method of claim 19, wherein setting the maximum data transfer rate of the first host to the throttle value is accomplished by Application Programming Interface (API) calls from an application executing on the first host to a sockets layer of the first host.

21. The method of claim 19, wherein transmitting data packets from the first host to the second host at a data transfer rate that is less than or equal to the throttle value is accomplished by use of a User Datagram Protocol (UDP) transport layer and an Internet Protocol network layer.
